(19) United States
(12) Patent Application Publication
(10) Pub. No.: US 2018/0349829 A1
(43) Pub. Date: Dec. 6, 2018

(54) Method for Optimizing Employee Work Assignments

(71) Applicants: Vaughn Peterson, Provo, UT (US); Jacob Christensen, Syracuse, UT (US); David Bean, West Bountiful, UT (US); Hunter Sebresos, Lehi, UT (US); Jon Moody, Highland, UT (US); Lloyd Weffer, Provo, UT (US); Trevor Peterson, West Jordan, UT (US); Thomas Rich, Mesquite, NV (US); Joe Fox, Spanish Fork, UT (US); Kevin Judd, Provo, UT (US)

(72) Inventors: Vaughn Peterson, Provo, UT (US); Jacob Christensen, Syracuse, UT (US); David Bean, West Bountiful, UT (US); Hunter Sebresos, Lehi, UT (US); Jon Moody, Highland, UT (US); Lloyd Weffer, Provo, UT (US); Trevor Peterson, West Jordan, UT (US); Thomas Rich, Mesquite, NV (US); Joe Fox, Spanish Fork, UT (US); Kevin Judd, Provo, UT (US)

(21) Appl. No.: 15/611,097

(22) Filed: Jun. 1, 2017

(51) Int. Cl. G06Q 10/06; G06Q 10/10

(52) U.S. Cl. CPC G06Q 10/063112; G06Q 10/063116; G06Q 10/107; G06Q 10/1091; G06Q 10/06393

(57) ABSTRACT

A method of optimizing employee work assignments comprises obtaining first and second key performance indicators (KPIs), performing a difference analysis on the first and second KPIs, correlating workplace productivity to the differences of the first and second KPIs, and optimizing employee work assignments based on productivity needs of the business. First KPIs may be for each employee of a plurality of employees. The second KPIs may be of one or more employee work groups associated with the plurality of employees. The analysis may be of difference correlations between the first KPIs and the second KPIs to determine synergistic relationships between specific employee groupings of the plurality of employees. The optimization of the employee work assignments may be an assignment given to each employee of the plurality of employees to optimized employee groupings based on the difference correlations of the first KPIs and the second KPIs.

### BACKGROUND

### Field of the Invention

The present invention relates generally to methods that optimize employee work assignments. Examples of typical methods include the use of key performance indicators (KPIs) in order to analyze the strengths and weaknesses of each employee in an enterprise. These KPIs can be in areas such as marketing, sales, manufacturing, or supply chain management.

### Background of the Invention

For example, U.S. patent Ser. No. 11/528,267 to Korenblit et al., describes a method for providing information to facilitate operations at a customer center. The method may monitor schedules for agents and KPIs of the agents. The monitoring determines whether there is a variance in any of the schedules and whether the KPIs are below a quality threshold. In response to this determining, it is determined whether to include a drill through option on a graphical user interface that includes root cause information indicating why the variance occurred to the schedule and why the KPIs fell below the threshold.

Despite the advances in methods that optimize employee work, improved methods are desirable.

### BRIEF SUMMARY OF THE INVENTION

Working in an optimized employee team can provide motivation, synergistic energy, increased emotional satisfaction, increased work production, and increased profits. Working in an unoptimized employee team can provide distractions, energy loss, decreased emotional satisfaction, decreased work production, contention among employees, and decreased profits. Employee personalities each have unique strengths and weaknesses which can be synergistically grouped into teams or shifts of optimized employee groups resulting in increased employee morale and employee productivity.

A method of optimizing employee work assignments comprises obtaining first key performance indicators (KPIs), obtaining second KPIs, analyzing differences between the first and second KPIs, and optimizing employee work assignments based on the analyzed differences, and assigning the employees to the optimized employee work assignments. First KPIs are determined for each of a plurality of employees. Second KPIs are determined for one or more employee work groups, teams, or shifts associated with the plurality of employees. The analysis may be of difference correlations between the first KPIs and the second KPIs to determine synergistic relationships between specific employee groupings of the plurality of employees as is explained in further detail in relation to FIGS. 1-10. Optimization of the employee work assignments may be accomplished by one or more computers with software programing which assign employees of the plurality of employees to optimized employee groupings, teams or shifts based on difference correlations of the first KPIs and the second KPIs.

First and second KPIs may comprise metrics such as sales, customer acquisition, customer attrition, customer satisfaction, employee satisfaction, time to complete work, work completed in a given amount of time, how much time spent in workplace, customer satisfaction, punctuality, innovation, or a combination thereof.

Time spent in the workplace may be monitored by geofencing applications on a cell phone. Geofencing applications may keep track of how much time an employee is in a designated area during a work shift.

Satisfaction of a customer or employee may be determined by surveys given to the customer or employee upon interacting with one or more customers or employees. These surveys may ask questions concerning their experience with one or more customers, employees, or groups of customers and/or employees.

An innovation metric of one or more employees may be determined by the number of effective ideas or solutions to problems one or more employees come up with which positively impacts an organization or enterprise.

Work completed in a given amount of time by one or more employees may be determined by a number of phone calls taken or placed, a number of items scanned, moved, and/or inventoried, a number of transactions processed, or a combination thereof by said one or more employees.

Difference correlations may be between the first KPIs of individual employees, the second KPIs of specific employee groupings, or two or more employees working separately and together. Optimized employee groupings may be determined by the difference correlations of the first KPIs and the second KPIs as is explained in further detail in relation to FIGS. 1-10. The optimized employee groupings may be made up of employees working a same shift.

A third party management company/software may be in charge of employee work assignments. This may help to eliminate any ill feelings employees may have towards their employers for the employee work assignments they are given.

### BRIEF DESCRIPTION OF THE DRAWINGS

FIG. 1 shows a diagram of a method for optimizing employee work assignments in accordance with an embodiment of the invention.

FIG. 2 shows a table in accordance with an embodiment of the invention.

FIG. 3 shows a table in accordance with an embodiment of the invention.

FIG. 4 shows a table in accordance with an embodiment of the invention.

FIG. 5 shows three tables in accordance with an embodiment of the invention.

FIG. 6 shows a table in accordance with an embodiment of the invention.

FIG. 7 shows two tables in accordance with an embodiment of the invention.

FIG. 8 is a schematic representation of a system and method for optimizing an employee work assignment in accordance with an embodiment of the invention.

FIG. 9 is a schematic representation of a system and method for optimizing an employee work assignment in accordance with an embodiment of the invention.

FIG. 10 is a perspective view of a system and method for optimizing an employee work assignment in accordance with an embodiment of the invention.

### DETAILED DESCRIPTION OF THE INVENTION

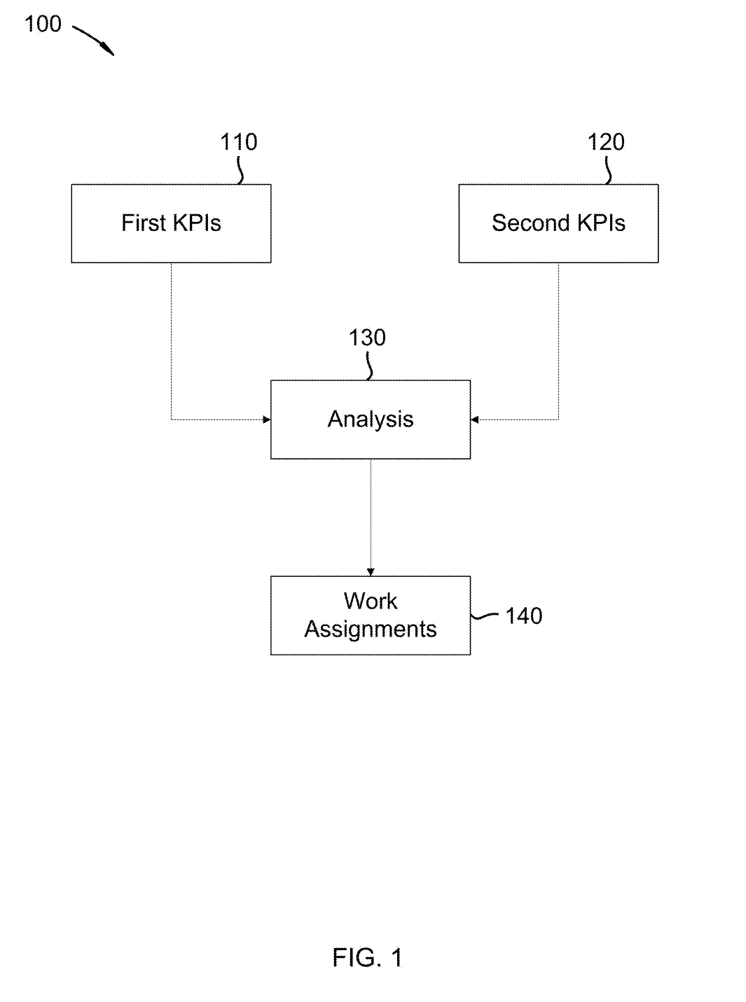

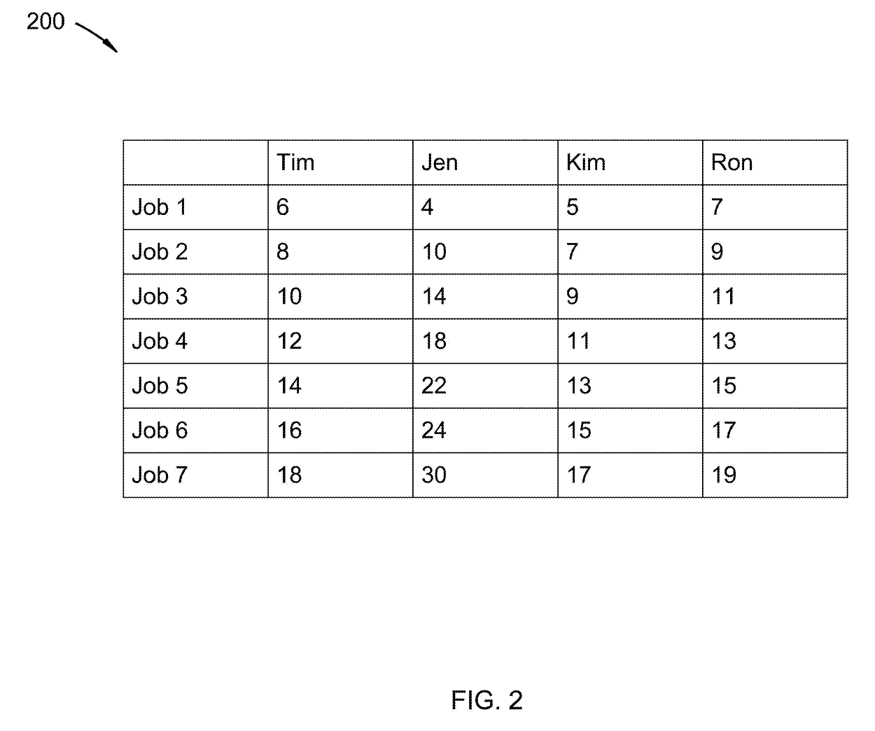

FIG. 1 shows generally, at 100, a system and method for optimizing employee work assignments in accordance with an embodiment of the invention. First KPIs (key performance indicators) 110 are metrics of performance of an employee. KPI metrics 110 may include sales, work quality, production level, service level agreement, project management, marketing, employee relations, time to complete work, work completed in a given amount of time, an amount of time spent in a workplace or on a given task, customer satisfaction, punctuality, customer acquisition, customer attrition, customer satisfaction, employee satisfaction, time to complete a specific work assignment, an amount work completed in a given amount of time, customer service, and employee innovation/problem solving. Second KPIs (key performance indicators) 120 are metrics of performance of two or more employees working in a group, shift, team, or cooperative joint work effort. KPI metrics 120 may include sales, production amount or level, work quality, service level agreement, project management, marketing, employee relations, time to complete work, work completed in a given amount of time, an amount of time spent in a workplace or on a given task, customer satisfaction, punctuality, customer acquisition, customer attrition, customer satisfaction, employee satisfaction, time to complete a specific work assignment, an amount work completed in a given amount of time, customer service, and employee innovation/problem solving. Analysis system 130 receives inputs from both first KPIs 110 and second KPIs 120 and analyzes differences and correlations between the first KPIs 110 and the second KPIs 120 as is explained in greater detail in relation to FIGS. 2-10. One or more computers, cell phones, databases, servers, clouds, and/or networks of computers may be configured to execute one or more software programs in order to perform the functions of analysis system 130 and/or work assignment system 140. Work assignment system 140 may be collocated with analysis system 130 in a cloud environment or may be remotely positioned in a local intranet, local network, or within one or more employee/employer devices such as a cell phone application program and/or computer. Work assignments system 140 may receive analyzed performance metric data from analysis system 130 indicating performance, performance trends, and/or statistically significant results of employees working alone, working in groups, and employees working in specific groups. Work assignment system 140 may make dynamic work assignments based on the received analyzed performance metric data. Dynamic work assignments may include specific grouping of employees into shifts of employees that work at higher performance levels when grouped together, teams of employees work at higher productivity when grouped together, and/or individual employees assigned to a specific task or job without a group.

FIG. 2 shows an example of a balanced scorecard 200 which may be used to keep track of the first KPIs for each employee. First KPIs are represented by each of the numbers within Table 200. Table 200 is set up in a way to show the KPI each employee receives for each respective job 1-7. Jobs 1-7 may each be different jobs or assignments. The KPIs may represent one or more of sales, production, service level agreement, project management, marketing, employee relations, time to complete work, work completed in a given amount of time, how much time spent in workplace, customer satisfaction, punctuality, and innovation. The KPI may be a weighted score. If the KPI represents the time to complete work, then the score may be the time itself in seconds, minutes, hours, days, or any other measurement of time. If the KPI represents sales, then the score may be the number of sales made in a given time period. Other methods may be used to come up with a score. The score may be better if it is lower, or it may be better if it is higher depending on the method used to come up with the score. The table 200 may be stored in a database server, cloud server, or device local to the employer such as an employer computer. For sake of example, let's assume that KPIs of Table 200 are hours to complete Jobs 1-7 and are a rolling average of the last 10 sample times for each employee for each Job. Job 1 shows that Jen is the fastest at 4 hours and Ron is the slowest 7 hours. For Job 7, Kim is the fastest at 17 hours and Jen is the slowest at 30 hours.

The KPIs of table 200 may represent averages of a predetermined number of samples or may be a running average of all samples to date. An employer may configure the analysis system 130 to produce sample averages of employee data of the last month, week, year, day, hour, or use every sample to date depending on the business needs, type of business, type of task, or type of job.

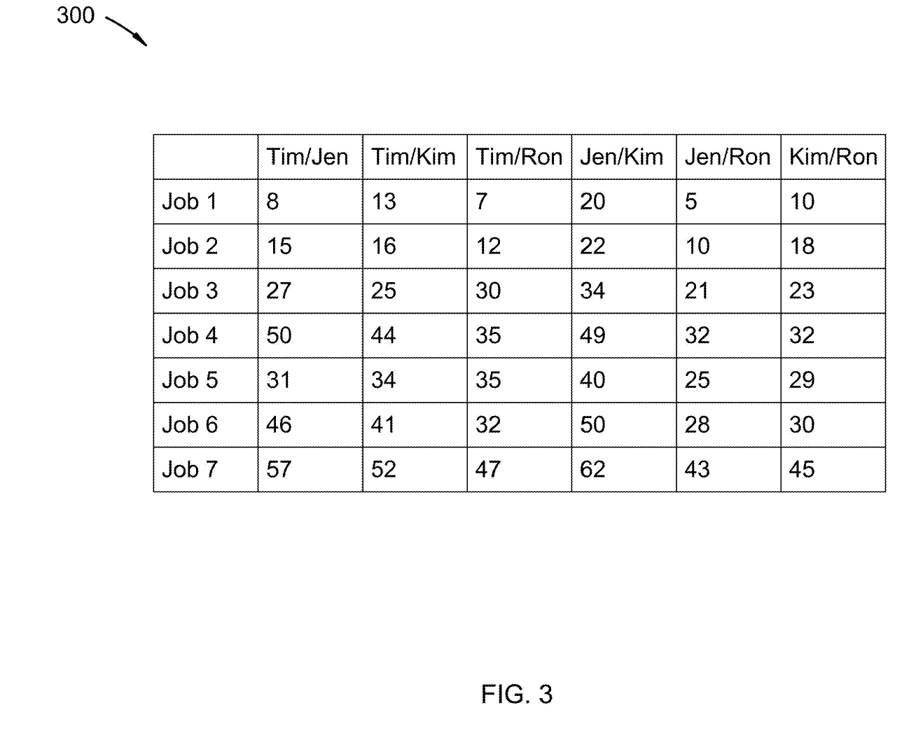

FIG. 3 shows an example of a balanced group or team scorecard 300 which may be used to keep track of the second KPIs for groups of employees of Table 200. Second KPIs are represented by each of the numbers within Table 300. Table 300 is set up in a way to show the KPI each employee group receives for each respective Job 1-7 and directly correlates to the same Jobs 1-7 shown in FIG. 2 at 200. Jobs 1-7 may each be different jobs or assignments. The KPIs may represent one or more of sales, production, service level agreement, project management, marketing, employee relations, time to complete work, work completed in a given amount of time, how much time spent in workplace, customer satisfaction, punctuality, and innovation. The KPI may be a weighted score. If the KPI represents the time to complete work, then the score may be the time itself in seconds, minutes, hours, days, or any other measurement of time. If the KPI represents sales, then the score may be the number of sales made in a given time period. Other methods may be used to come up with a score. The score may be better if it is lower, or it may be better if it is higher depending on the method used to come up with the score. The table 300 may be stored in a database server, cloud server, or device local to the employer such as an employer computer. Continuing with the same example of FIG. 2, let's assume that KPIs of Table 300 are hours to complete Jobs 1-7 and are a rolling average of the last 10 sample times for each employee group for each Job 1-7. Job 1 shows that team Tim/Jen is the fastest at 2 hours and team Jen/Kim is the slowest at 10 hours. In this example Jen is both on the fastest team and the slowest team. Jen and Kim working together as a team are less productive than Jen and Tim working together as a team. This information may be received by work assignment system 130 and work assignments may be given with Jen and Kim on different shifts, at different locations, or working different days. The data of Table 300 shows that Tim's productivity goes up while working with Jen on Job 1 and goes down while working with Kim on Job 1. An employee's productivity while working alone (shown in Table 200) may be used a reference point to determine if working as a team increases or decreases productivity. In Table 200, it takes Ron 7 hours to complete Job 1. In Table 300, Jen and Ron working together complete the same Job 1 in 2.5 hours. This represents a substantial increase in Job productivity when Ron and Jen work together.

The KPIs of table 300 may represent averages of a predetermined number of samples or may be a running average of all samples to date. An employer may configure the analysis system 130 to produce sample averages of employee data of the last month, week, year, day, hour, or use a cumulative sample data set depending on the business needs, type of business, type of task, or type of job. Table 300 shows groups of two employees only, but the groups may be of two or more employees. The KPIs may represent one or more of sales, production, service level agreement, project management, marketing, employee relations, time to complete work, work completed in a given amount of time, how much time spent in workplace, customer satisfaction, punctuality, and innovation. Table 300 may show scores of the KPIs of every possible combination of employees from the table 200.

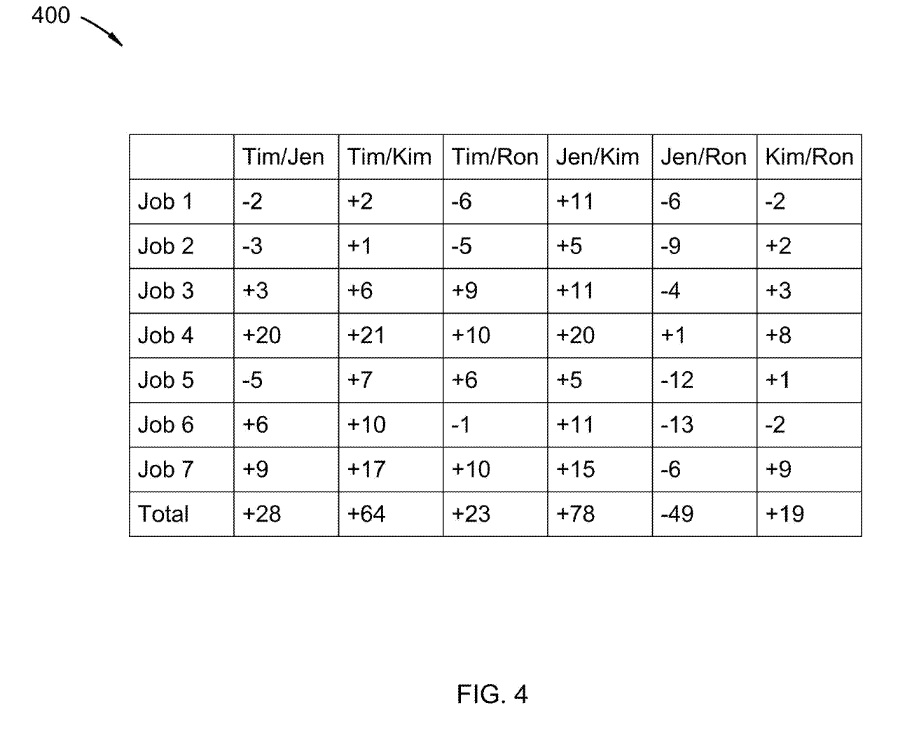

FIG. 4 shows an example of difference correlations between first KPIs and second KPIs in accordance with an embodiment of the invention. Table 400 shows a difference score to each group by taking the difference between the second KPIs from FIG. 3 and the first KPIs from FIG. 2. A lower score means that a group has synergistic energy. If the score is negative, then the two or more employees work better as a group than they do separately for that particular job. If the score is positive, then the two or more employees work better separately than they do as a group for that particular job. Difference correlations shown are the numbers in the table. Difference correlations were calculated by adding the individual time to complete each Job in Table 200 of the employee group members of Table 300 and then dividing by the number of the group to come up with an average time baseline for the group. For example, Tim and Jen took 6 hours and 4 hours to individually complete Job 1, the average being 5 hours. When Tim and Jen worked together on the same Job, the Job was complete in 2 hours. This represents a synergistic group energy of −3 hours shown in Table 4 at Job 1 for the team of Tim/Jen. From the table 400, it can be seen that groups of employees have positive scores and groups of employees have negative scores for various Jobs. Employees groups with positive numbers work more productively alone compared to the specific grouping and Job. Employee groupings with negative numbers work better in the specific groups compared to working alone for the specific Jobs. The difference correlations shown in Table 400 may be used to form dynamic employee groupings based on synergistic groupings for specific jobs. Totals show a combined number of hours relative to working in the specific groups compared to working alone with the same Jobs 1-7. If Tim and Jen work together on Jobs 1-7 they will get done faster with all Jobs 31 hours sooner compared to working alone on the same Jobs 1-7. If Jen and Kim work together on the same Jobs 1-7 the will take 38 hours longer compared to working alone on the same Jobs 1-7. This demonstrates the increased productivity Jen exhibits when working with Tim compared to working with Kim.

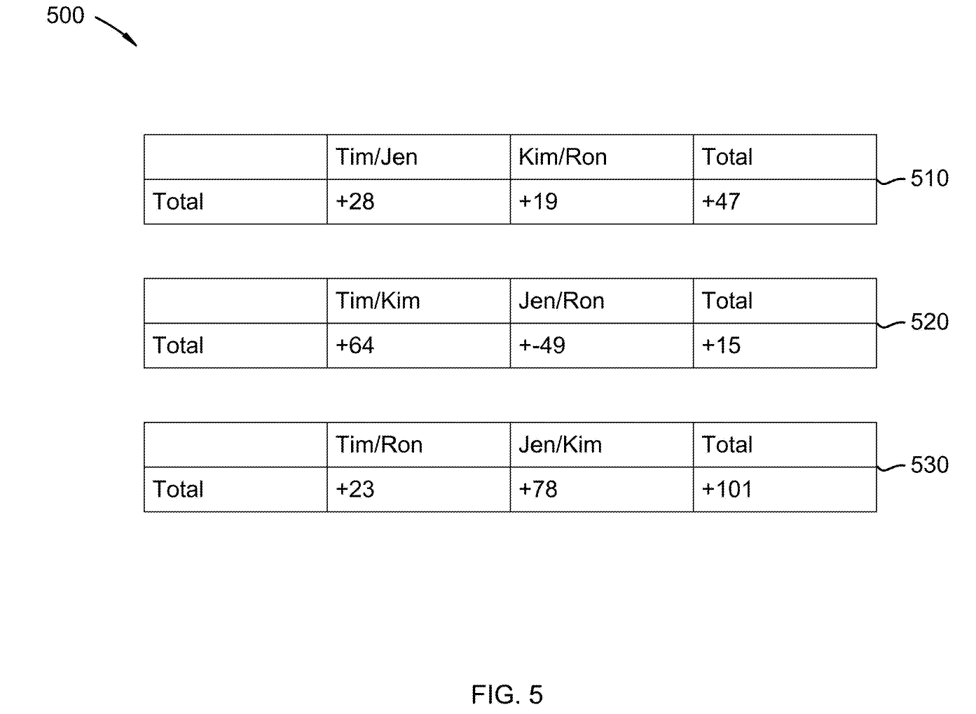

FIG. 5 shows an embodiment of a method 500 for forming groups. The method 500 gives a total score to each combination of groups 510, 520, and 530 possible from the table 400. A lower score means that a combination of groups has more synergy and the ability to be more productive. This may be beneficial in scheduling and balancing forecasted workloads due to holiday sales or increased production demands. As seen in FIG. 5, the combination of groups 510 has the ability to be most productive based on the group 510 of employee groups. The groups in the combination of groups 510, 520, and 530 may be formed to meet specific forecasted business demands. The method 500 may be used to assign employees to different shifts, different locations, and/or different Jobs.

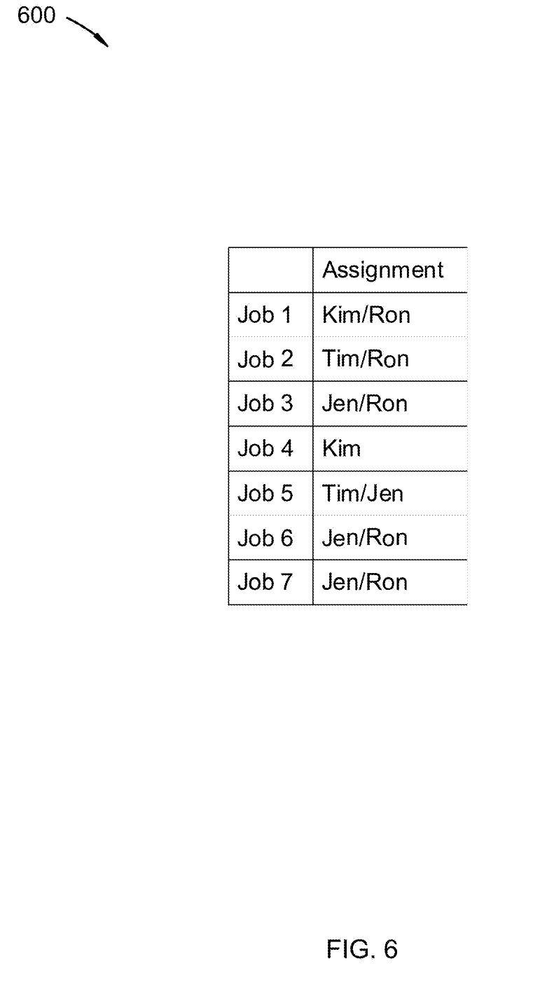

FIG. 6 shows an embodiment of a method 600 for forming groups. The method 600 assigns each group to a job. With the method 600 each group may be assigned one or more times. If a group does not work better together than separately for any of the jobs, such as Tim and Kim or Jen and Kim, then that group may not be assigned any job. The jobs for which none of the groups work better together than separately such as Job 4, then none of the groups may be assigned to that job, and the employee who does the job best may be assigned Job 4. In this case Kim does Job 4 best, so she would be assigned Job 4. Other deviations to the method 600 may be made in order to fit the needs of the company. If each employee is to work only one job, then the groups may be assigned to each job in a way that meets that need. For the example presented in FIG. 6, there may need to be a greater pool of employees in order for each job to be filled.

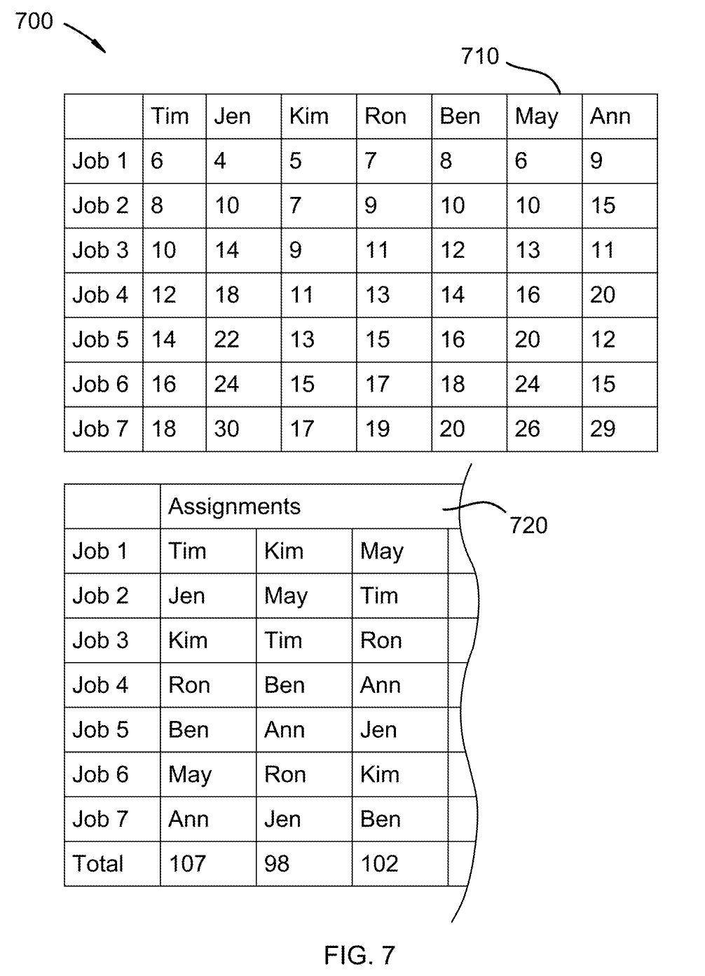

FIG. 7 shows an embodiment of a method 700 for assigning individual employees to a job. The method 700 shows a table 710 and a table 720. The table 710 is similar to the table 200. The table 710 gives weighted scores to seven employees. The table 720 shows individual employee work assignments to each job and the total score for those employee work assignments. In this case, the combination with the lower score would be preferable. Balanced total workloads/productivity may be desirable when forming an optimized employee group as shown in FIG. 7.

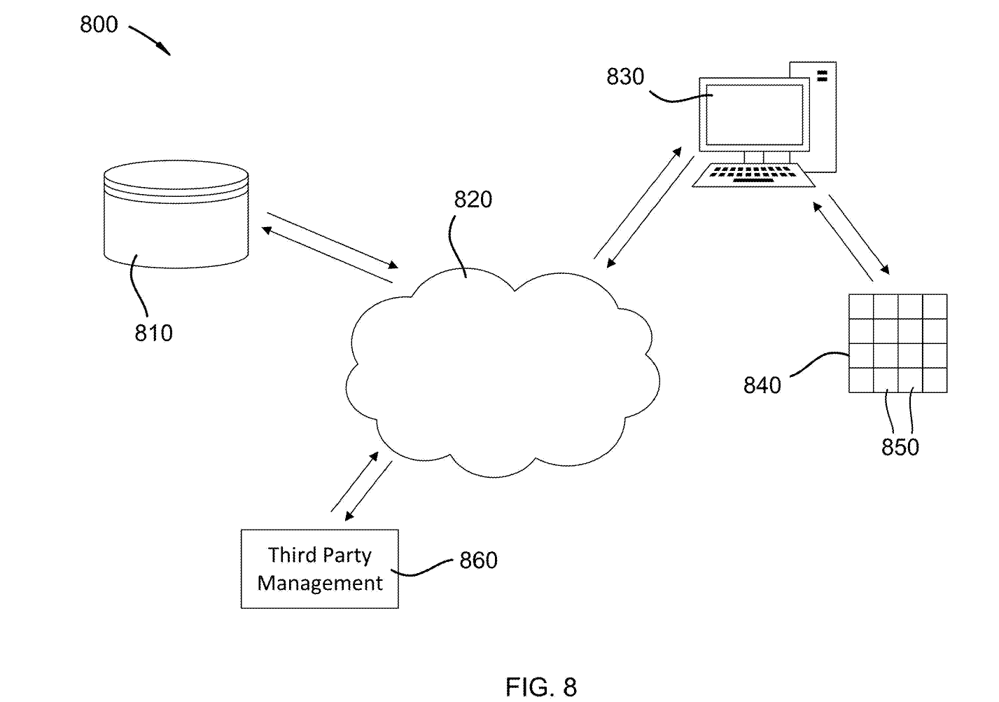

FIG. 8 shows an embodiment of a method 800 for optimizing employee work assignments 850 for a location 840. A database server 810 may store and process first and second KPIs received from one or more work locations 840. A third party management company 860 may communicate with cloud database 810 and/or computer 830 and may make employee work assignments 850 based on information received by way of Internet 820. The third party management company/software 860 may communicate back and forth over the Internet 820 or be part of a local workplace network. Work location 840 may communicate back and forth over the Internet 820 through one or more computers 830. Computers 830 may receive input about the first and second KPIs of the work location 840, communicate that information over the Internet 820, and transmit back to work location 840 dynamic work assignments based on specific workplace productivity and staffing needs.

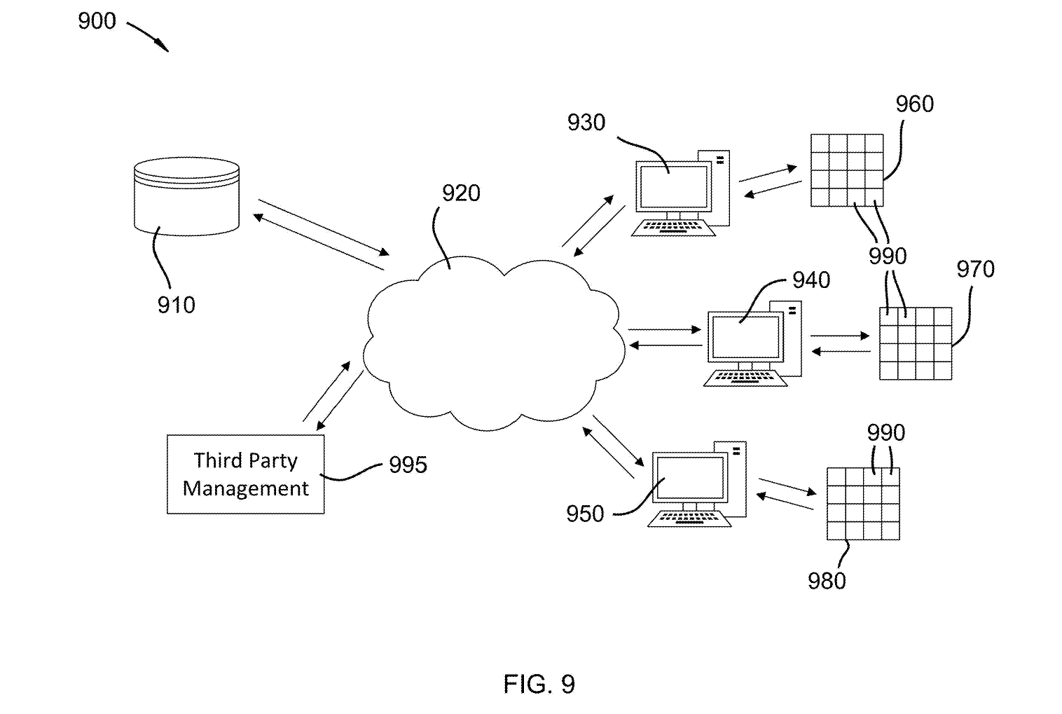

FIG. 9 shows an embodiment of a method 900 for optimizing employee work assignments 990 for work locations 960, 970, and 980. A database server 910 communicates back and forth over the Internet 920 and receives information about the first and second KPIs of the locations 960, 970, and 980. A third party management company 995 may make dynamic employee work assignments 990 based on difference correlations of first and second KPIs. The third party management company 995 may communicate back and forth over the Internet 920 to computers 930, 940, and 950. The computers 930, 940, and 950 may receive input about the first and second KPIs of the work locations 960, 970, and 980 respectively, and communicate information over the Internet 920 and transmit finalized dynamic work assignments to employees. Computers 930, 940, and 950 may be cell phones, desktops, laptops, and/or business computers such as point-of-sale computers.

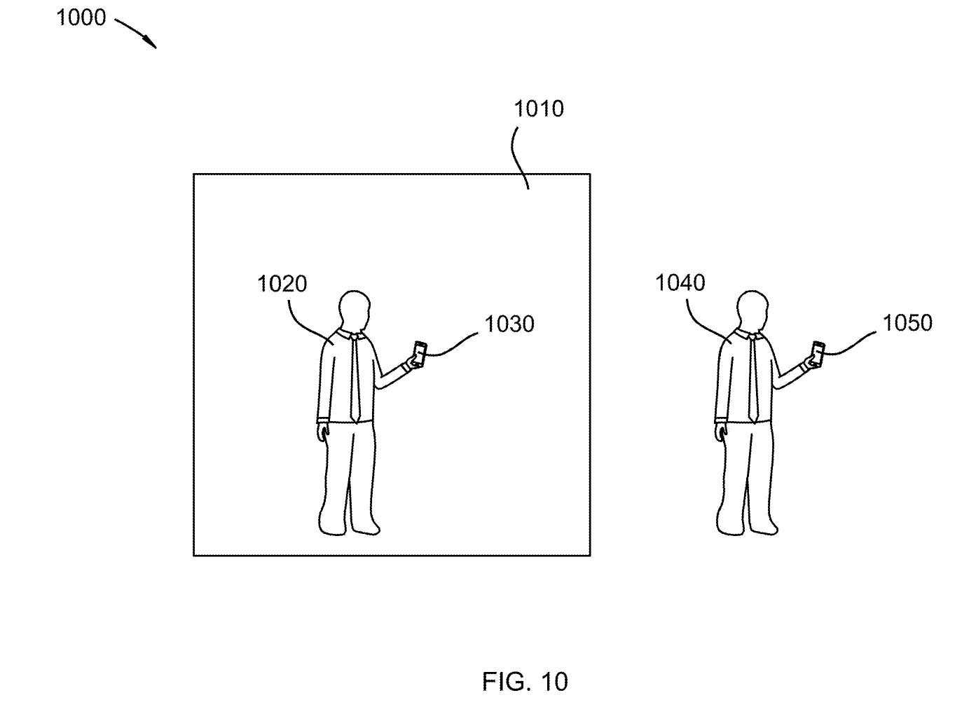

FIG. 10 shows an embodiment of a method 1000 for keeping track of how long an employee remains in the workplace 1010. The method may use a geofencing application. Employees 1020 and 1040 may have cell phones 1030 and 1050, which have the geofencing application. The application keeps track of when employees 1020 and 1040 are in the workplace 1010. Employee 1020 would be considered to be in the workplace 1010 according to the geofencing application on the cell phone 1030. The employee 1040 would be considered to be outside of the workplace 1010 according to the geofencing application on the cell phone 1050. The employees 1020 and 1040 may receive a better KPI score for the amount of time in the workplace 1010 the longer amount of time they remain in the workplace 1010. Cell phone 1050 may also keep track of employee sales data, employee position data, employee movement data, and provide input fields for employee and/or customer feedback. First and second KPIs may be obtained by non-intrusive data gathering such as video, audio, automated tracking of employee sales, number or units produced by a factory employee, number of items scanned by a specific employee, number of items inventoried, a number of phone calls placed, an amount of time on the phone, a volume of product moved, and other known metrics for determining employee productivity.

What is claimed is:

1. A method of optimizing employee work assignments comprising:
obtaining first key performance indicators (KPIs) for each employee of a plurality of employees, the first KPI representing a metric of an assigned task carried out individually by each employee of the plurality of employees;
obtaining second KPIs of one or more employee work groups associated with the plurality of employees, the second KPIs representing a metric of the assigned task carried out by each of the one or more employee work groups associated with the plurality of employees;
averaging the first KPIs of employees associated with the one or more employee work groups;
subtracting the averaged first KPIs of the employees associated with the one or more employee work groups from the second KPIs of the one or more employee work groups associated with the plurality of employees to obtain difference values;
assigning group productivity indicators to each of the one or more employee work groups based on the difference values;
optimizing the employee work assignments by assigning employees of the plurality of employees to optimized employee work groups, teams, or shifts based on the assigned group productivity indicators; and
sending notifications to the plurality of employees of their assignments to the optimized employee work groups, teams, or shifts.

2. The method of claim 1, wherein the first KPIs and second KPIs comprise one or more of:
sales, production, service level agreement, project management, marketing, employee relations, time to complete work, work completed in a given amount of time, how much time spent in workplace, customer satisfaction, punctuality, and innovation.

3. The method of claim 2, wherein the sales KPIs comprise one or more of: customer acquisition, customer attrition, cost of sales to revenue ratio, sales growth, average sales cycle, and average follow-up attempts.

4. The method of claim 2, wherein the production KPIs comprise one or more of: count, reject ratio, rate, target, and takt time.

5. The method of claim 2, wherein the service level agreement KPIs comprise one or more of: percentage of customer issues resolved by the first phone call, number of answered phone calls in a given time period, number of un-responded emails, and number of complaints received.

6. The method of claim 2, wherein the project management KPIs comprise one or more of: planned hours of work vs actual hours worked, percent of projects completed on time, percent of projects on budget, cost of managing processes, return on investment.

7. The method of claim 2, wherein the marketing KPIs comprise one or more of: new leads, net promoter score, retention rate, click-through rate on web pages, and traffic from social media.

8. The method of claim 2, wherein the employee relations KPIs comprise one or more of: grievance rate, cost of grievance, time to resolve grievance, and employee relations return on investment.

9. The method of claim 2, wherein the punctuality KPI is measured by a time that the employee is supposed to clock in and a time the employee actually clocks in.

10. The method of claim 2, wherein the time spent in workplace is monitored by geofencing applications on a cell phone.

11. The method of claim 2, wherein customer satisfaction is determined by customer surveys.

12. The method of claim 1, wherein a third party management company gives out the employee work assignments.

13. The method of claim 2, wherein the work completed in a given amount of time is determined by one or more of: a number of phone calls taken or placed by an employee or a group of employees, a number of items scanned or inventoried by an employee or a group of employees, and a number of transactions processed by an employee or a group of employees.

14. The method of claim 1, wherein the difference correlations are based in part on averages of the first KPIs between two or more employees.

15. The method of claim 1, wherein the difference correlations between the second KPIs are between the specific employee groupings and an average of the first KPIs.

16. The method of claim 1, wherein the difference correlations between the first KPIs and the second KPIs are between two or more employees working separately and together.

17. The method of claim 1, wherein the optimized employee groupings are of employees working a same shift.

18. The method of claim 1, wherein the optimized employee groupings are determined by the difference correlations between the first KPIs and the second KPIs and a forecast productivity needed to meet business demand.

19. The method of claim 16, wherein the difference correlations are based on one or more of: sales, production, service level agreement, project management, marketing, time to complete work, work completed in a given amount of time, how much time spent in workplace, customer satisfaction, punctuality, and innovation of the two or more employees working separately and together.

20. The method of claim 1, wherein work assignments are made using a cloud based network.
